(19) United States
(12) Patent Application Publication
(10) Pub. No.: US 2025/0219995 A1
(43) Pub. Date: Jul. 3, 2025

(54) NETWORK SECURITY DEVICE TO SECURE WI-FI ENABLED DEVICES FROM CYBERTHREATS

(71) Applicant: Sarveshwar Meta Rao, Sacramento, CA (US)

(72) Inventor: Sarveshwar Meta Rao, Sacramento, CA (US)

(21) Appl. No.: 18/999,492

(22) Filed: Dec. 23, 2024

Related U.S. Application Data
(60) Provisional application No. 63/615,224, filed on Dec. 27, 2023.

(51) Int. Cl. H04L 9/40

(52) U.S. Cl. CPC H04L 63/0236; H04L 63/1416

(57) ABSTRACT

Embodiments herein provide a network security device that operates as a network security gateway for securing Wi-Fi-enabled devices. The network security device includes a memory that includes a set of instructions and a processor that executes a set of instructions. The set of instructions includes (i) converting an unsecured Wi-Fi network that is generated by the ISP router into a secured Wi-Fi network using a Wide Area Network (WAN) interface that is communicatively connected to the ISP router, (ii) monitoring network traffic between the WAN interface and a Local Area Network (LAN) interface to block unauthorized network traffic from reaching the Wi-Fi-enabled devices and the ISP router, and (iii) routing network traffic to the secured Wi-Fi network through the LAN interface that is communicatively connected to the Wi-Fi-enabled devices to provide a secure internet connection to the Wi-Fi-enabled devices.

### BACKGROUND

### Technical Field

The embodiments herein generally relate to cybersecurity, more particularly, to a network security device that operates as a network security gateway for securing Wi-Fi-enabled devices from cyber threats.

### Description of the Related Art

In an era where digital connectivity is integral to daily life, the prevalence of cyberattacks targeting home networks and businesses has surged dramatically. With the rapid adoption of internet-connected smart devices or IoT devices, the attack surface for cyber threats has expanded significantly. Moreover, many of these devices lack robust built-in security measures, leaving individuals and businesses increasingly vulnerable to sophisticated cyberattacks, including phishing, ransomware, and malware.

Traditional enterprise-grade security solutions such as firewalls, intrusion detection/prevention systems (IDS/IPS), DNS security, URL filtering, and zero-day protection. These solutions are unsuitable for small businesses with fewer than 20 employees or households without dedicated technical expertise. Consumer-grade antivirus software and browser security measures also fall short. They do not secure all connected devices, including IoT/smart devices such as doorbells, cameras, and appliances, and protect against phishing and network-based attacks.

Wireless routers, commonly used in small business and home networks, often fail to provide sufficient security. Firmware and software vulnerabilities frequently go unpatched, default passwords and configurations remain unchanged, and basic security features are disabled or improperly configured. Moreover, these routers lack the advanced capabilities necessary to combat modern cyber threats effectively. Consumer-grade VPN solutions primarily focus on IP anonymity and privacy, leaving users vulnerable to various internet-based threats such as phishing, malware, and ransomware. Additionally, they do not secure connected IoT/smart devices in home or small-business networks.

FIG. 1 is a block diagram of a system that illustrates a process of connecting one or more user devices 106A-N to an Internet Service Provider (ISP) router 104, either through Ethernet cables or unsecured Wi-Fi, in accordance with prior art. The system includes an ISP unit 102, the ISP router 104, and the one or more user devices 106A-N.

The ISP router 104 connects to the ISP unit 102 to obtain internet access. The ISP router 104 is connected to the ISP unit 102 and serves as the central access point for the one or more user devices 106A-N, facilitating internet connectivity. The one or more user devices 106A-N (e.g., PCs, smartphones, IoT devices) connect to the ISP router 104 either through Ethernet cables (wired connection), or unsecured Wi-Fi Network (wireless connection). However, this system does not support connecting a network security gateway to the ISP router 104 using Wi-Fi. This limitation is a critical barrier for non-technical users who prefer simple and wireless setups. To get internet connectivity to the security gateway, this system\requires the user to adopt cumbersome methods such as connecting Ethernet cable from the WAN port of the security gateway to the LAN ports of the ISP router 104. Moreover, the non-technical individuals in small-businesses and consumers do not prefer to do cabling or other technical configuration and therefore do not utilize network-based cybersecurity gateways in their offices or homes.

Moreover, a significant limitation of the system is its restricted Wi-Fi coverage. The range of Wi-Fi coverage is typically confined to the area reachable from the Ethernet cable connection point, which serves as the primary source of internet connectivity. This limitation becomes particularly problematic in environments requiring extensive or distributed Wi-Fi coverage. To address this, users often need to deploy additional infrastructure, such as Wi-Fi repeaters, to extend the coverage area. However, this approach introduces several challenges, including increased deployment complexity, higher costs, and additional configuration efforts. Moreover, the reliance on repeaters can lead to inefficiencies such as signal latency, reduced bandwidth, and security vulnerabilities in the extended network.

In a wireless gateway deployment model, attaining high performance depends on selecting the optimal Wi-Fi channel for both the WAN and LAN Wi-Fi radios. However, many internet service provider (ISP) routers adjust the Wi-Fi channel based on changing surrounding network conditions. If the wireless gateway uses static channels for its Wide Area Network (WAN) and Local Area Network (LAN) interfaces, it can experience significant performance degradation whenever the ISP router changes its Wi-Fi channel. This channel switching results in a dramatic loss of network throughput, undermining the gateway's performance and its ability to maintain secure and efficient network operations.

Accordingly, there remains a need for a more efficient method for mitigating and/or overcoming drawbacks associated with current methods.

### SUMMARY

In view of the foregoing, an embodiment herein provides a network security device that operates as a network security gateway for securing Wi-Fi-enabled devices. The network security device includes a memory that includes a set of instructions. The network security device includes a processor that executes the set of instructions. The processor includes converting an unsecured Wi-Fi network that is generated by the ISP router into a secured Wi-Fi network using a Wide Area Network (WAN) interface that is communicatively connected to the ISP router. The processor includes monitoring network traffic between the WAN interface and a Local Area Network (LAN) interface to block unauthorized network traffic from reaching the Wi-Fi-enabled devices and the ISP router. The processor includes routing network traffic to the secured Wi-Fi network through the LAN interface that is communicatively connected to the Wi-Fi-enabled devices to provide a secure internet connection to the Wi-Fi-enabled devices.

In some embodiments, the set of instructions further includes (i) detecting an operating frequency band of the ISP router, (ii) determining optimal frequency bands for the Wi-Fi-enabled devices based on the operating frequency band detected for the ISP router, (iii) dynamically assigning the first radio channel module to the WAN interface or the LAN interface based on the operating frequency band detected for the ISP router and the optimal frequency bands of the Wi-Fi-enabled devices, and (iv) dynamically assigning the second radio channel module to the LAN interface or the WAN interface based on the operating frequency band detected for the ISP router and the optimal frequency bands of the Wi-Fi-enabled devices. The first radio channel module and the second radio channel module are dynamically assigned and configured to reduce interference.

In some embodiments, the set of instructions further includes extending the Wi-Fi coverage of the ISP router by communicatively connecting the WAN interface with the ISP router, wherein the WAN interface is configured to extend the Wi-Fi coverage of the ISP router and provide the secured Wi-Fi network to the Wi-Fi enabled devices connected to the ISP router.

In some embodiments, the set of instructions includes converting the unsecured Wi-Fi network into the secured Wi-Fi network when a user selects the unsecured Wi-Fi network among a plurality of available unsecured Wi-Fi networks in the environment.

In some embodiments, the set of instructions further includes (i) monitoring the network traffic between the WAN interface module and the LAN interface module to detect at least one event, (ii) determining whether the at least one event is associated with a predefined list provided by a user or third-party entities, and blocking the network traffic corresponding to the event if the event is associated with the predefined list.

In some embodiments, the predefined lists include at least one domain name associated with known malicious sources, Internet Protocol (IP) addresses, or IP addresses from countries selected by the user or third-party entities as blocked.

In some embodiments, the network security device includes a security layer that blocks unauthorized network traffic. The security layer includes a firewall and intrusion detection module, a Domain Name System (DNS) security module, and a web filtering and malware protection module.

In some embodiments, the set of instructions further includes updating the predefined lists dynamically at a predefined time.

In some embodiments, a method for a network security device that operates as a network security gateway for securing Wi-Fi-enabled devices is provided. The method includes converting an unsecured Wi-Fi network that is generated by the ISP router into a secured Wi-Fi network using a Wide Area Network (WAN) interface that is communicatively connected to the ISP router. The method includes monitoring network traffic between the WAN interface and a Local Area Network (LAN) interface to block unauthorized network traffic from reaching the Wi-Fi-enabled devices and the ISP router. The method includes routing network traffic to the secured Wi-Fi network through the LAN interface that is communicatively connected to the Wi-Fi-enabled devices to provide a secure internet connection to the Wi-Fi-enabled devices.

In some embodiments, the set of instructions further includes (i) detecting an operating frequency band of the ISP router, (ii) determining optimal frequency bands for the Wi-Fi-enabled devices based on the operating frequency band detected for the ISP router, (iii) dynamically assigning the first radio channel module to the WAN interface or the LAN interface based on the operating frequency band detected for the ISP router and the optimal frequency bands of the Wi-Fi-enabled devices, and (iv) dynamically assigning the second radio channel module to the LAN interface or the WAN interface based on the operating frequency band detected for the ISP router and the optimal frequency bands of the Wi-Fi-enabled devices. The first radio channel module and the second radio channel module are dynamically assigned and configured to reduce interference.

In some embodiments, the set of instructions further includes extending a Wi-Fi coverage of the ISP router by communicatively connecting the WAN interface with the ISP router, wherein the WAN interface is configured to extend the Wi-Fi coverage of the ISP router and provide the secured Wi-Fi network to the Wi-Fi enabled devices connected to the ISP router.

In some embodiments, the set of instructions includes converting the unsecured Wi-Fi network into the secured Wi-Fi network when a user selects the unsecured Wi-Fi network among a plurality of available unsecured Wi-Fi networks in the environment.

In some embodiments, the set of instructions further includes (i) monitoring the network traffic between the WAN interface module and the LAN interface module to detect at least one event, (ii) determining whether the at least one event is associated with a predefined list provided by a user or third-party entities, and blocking the network traffic corresponding to the event if the event is associated with the predefined list.

In some embodiments, the predefined lists include at least one domain name associated with known malicious sources, Internet Protocol (IP) addresses, or IP addresses from countries selected by the user or third-party entities as blocked.

In some embodiments, the network security device includes a security layer that blocks the unauthorized network traffic. The security layer includes a firewall and intrusion detection module, a Domain Name System (DNS) security module, and a web filtering and malware protection module.

In some embodiments, the set of instructions further includes updating the predefined lists dynamically at a predefined time.

The network security device inspects all traffic from the home or business network and the internet and blocks the network traffic associated with cyber threats. The network security device leverages its Wi-Fi-based connection to the home or business internet router to extend the range of Wi-Fi coverage, eliminating the need for additional Wi-Fi repeaters. Being entirely wireless and Wi-Fi-based on the WAN side, the network security device requires no new cabling to the internet router. This simplifies installation, enabling non-technical users to protect their network by powering on the network security device and using a mobile application for configuration. This process takes only a few minutes. The network security device allows the WAN interface of the network security device to connect wirelessly to the internet Wi-Fi router, while the Wi-Fi LAN interface connects to Wi-Fi-enabled devices. The network security device ensures high data throughput performance in a wireless gateway deployment mode by selecting optimal Wi-Fi channels for both the WAN and LAN radios. Even when internet service provider (ISP) routers dynamically adjust their Wi-Fi channels in response to surrounding network conditions, the network security device dynamically adapts its LAN Wi-Fi channel to maintain optimal throughput performance. The adaptive Wi-Fi channel selection module enables the network security device to deliver high throughput consistently. By assigning a LAN Wi-Fi channel opposite to the ISP router's channel within the spectrum, the network security device minimizes inter-radio interference and enhances overall performance for end-Wi-Fi enabled devices connected to the secure Wi-Fi network on the LAN interface.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram of a system that illustrates a process of connecting one or more user devices to an Internet Service Provider (ISP) router, either through Ethernet cables or unsecured Wi-Fi, in accordance with prior art;

FIG. 2 is a block diagram of a network security device that operates as a network security gateway for securing Wi-Fi-enabled devices according to some embodiments herein;

FIGS. 3A and 3B are block diagrams of a network security device that assigns radio channels to an Internet Service Provider (ISP) router and Wi-Fi-enabled devices, according to some embodiments herein;

FIG. 4 are block diagrams of a security layer that blocks unauthorized network traffic according to some embodiments herein;

FIG. 5 is an exemplary diagram illustrating the extension of a Wi-Fi coverage of an Internet Service Provider (ISP) router by a network security device according to some embodiments;

FIGS. 6A-D are exemplary user interface views that illustrate a network security device being connected to an Internet Service Provider (ISP) router of a user according to some embodiments;

FIG. 7 is a flow diagram that illustrates a method of a network security device that operates as a network security gateway Wi-Fi-enabled devices according to some embodiments herein; and

FIG. 8 is a schematic diagram of a computer architecture in accordance with the embodiments herein.

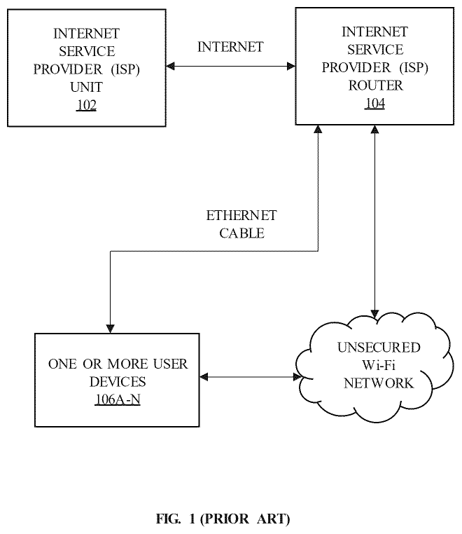

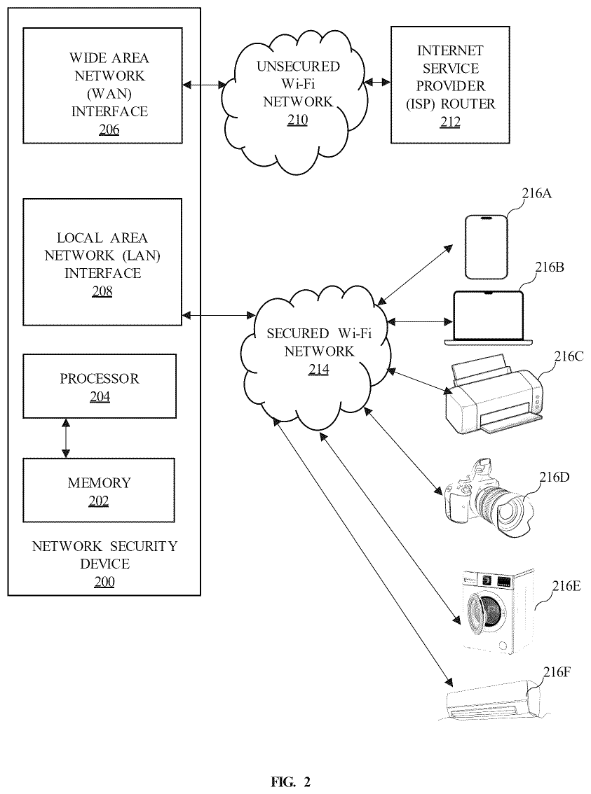

### DETAILED DESCRIPTION OF THE DRAWINGS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there is a need for a network security device that operates as a network security gateway for securing Wi-Fi-enabled devices according to some embodiments herein. Referring now to the drawings, and more particularly to FIGS. 2 through 8, where similar reference characters denote corresponding features consistently throughout the figures, preferred embodiments are shown.

### Definitions

An unsecured Wi-Fi network is a wireless network that requires a password to access the internet but lacks security protections. While the unsecured Wi-Fi network is password-protected, it may still be vulnerable to external threats and unauthorized access.

A secured Wi-Fi network refers to a wireless network that, after being connected to a network security device, is protected. After the user connects the network security device and enters the password of the unsecured Wi-Fi network, the network security device provides secured Wi-Fi network to protect the wireless network, making it safer from unauthorized access and threats.

FIG. 2 is a block diagram of a network security device 200 that operates as a network security gateway for securing Wi-Fi-enabled devices 216A-N according to some embodiments herein. The network security device 200 includes a memory 202, a processor 204, a Wide Area Network (WAN) interface 206, and a Local Area Network (LAN) interface 208. The memory 202 includes a set of instructions. The processor 204 executes the set of instructions. The ISP router 212 provides internet access to the Wi-Fi-enabled devices 216A-N by transmitting an internet signal over an unsecured Wi-Fi network 210 (i.e., an existing internet connection).

The WAN interface 206 connects wirelessly to the unsecured Wi-Fi network 210 provided by the ISP router 212. Once connected, the WAN interface 206 converts the unsecured Wi-Fi network 210 into the secured Wi-Fi network 214. The LAN interface 208 connects wirelessly to the Wi-Fi-enabled devices 216A-N using the secured Wi-Fi network 214. The LAN interface 208 routes network traffic to the secured Wi-Fi network 214 to provide a secure internet connection to the Wi-Fi-enabled devices 216A-N. The Wi-Fi-enabled devices 216A-N may include, but are not limited to, smartphones, laptops, tablets, TVs, speakers, printers, gaming consoles, washing machines, Air Conditioner (AC), or refrigerators. The internet connection from the ISP router 212 is routed through the secured Wi-Fi network 214 provided by the network security device 200. This means the internet connection from the ISP router 212 is distributed to the Wi-Fi-enabled devices 216A-N that connect to the secured Wi-Fi network 214. When the network security device 200 connects wirelessly to the ISP router 212 through WAN interface 206 and simultaneously provides wireless LAN connections to the Wi-Fi-enabled devices 216A-N. Once connected to the ISP router 212 wirelessly, the network security device 200 gains access to the internet through the ISP router 212. At the same time, the network security device 200 provides Wi-Fi access to smartphones, laptops, and other devices in an environment that can access the internet through the network security device 200.

The network security device 200 monitors network traffic that flows through the WAN interface 206 which is connected to the ISP router 212 and the LAN interface 208 which is connected to the Wi-Fi-enabled devices 216A-N. The network security device 200 detects and analyzes events in the network traffic. The network security device 200 determines whether the at least one event is associated with a predefined list provided by a user or third-party entities. The network security device 200 blocks the network traffic corresponding to the event if the event is associated with the predefined list. The network security device 200 blocks unauthorized network traffic from reaching the ISP router 212 and the Wi-Fi-enabled devices 216A-N.

The secured Wi-Fi network 214 provides a protected environment for the ISP router 212 and the connected Wi-Fi-enabled devices 216A-N. The network security device 200 monitors the incoming and outgoing network traffic between the ISP router 212 and the connected Wi-Fi enabled devices 216A-N.

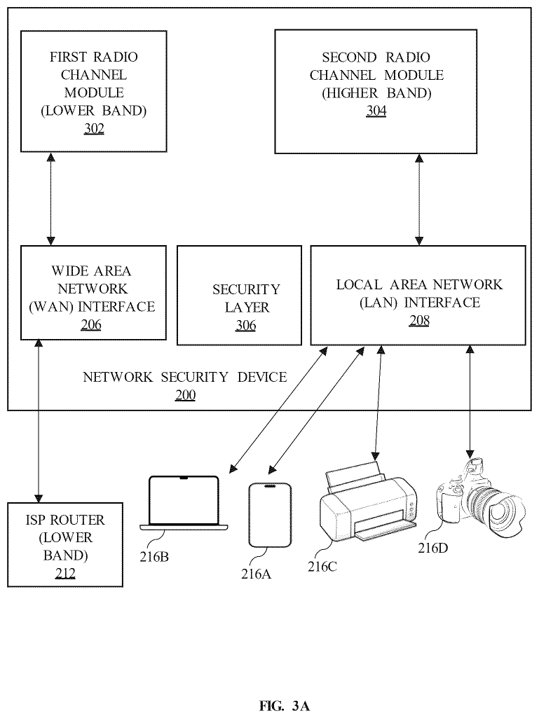

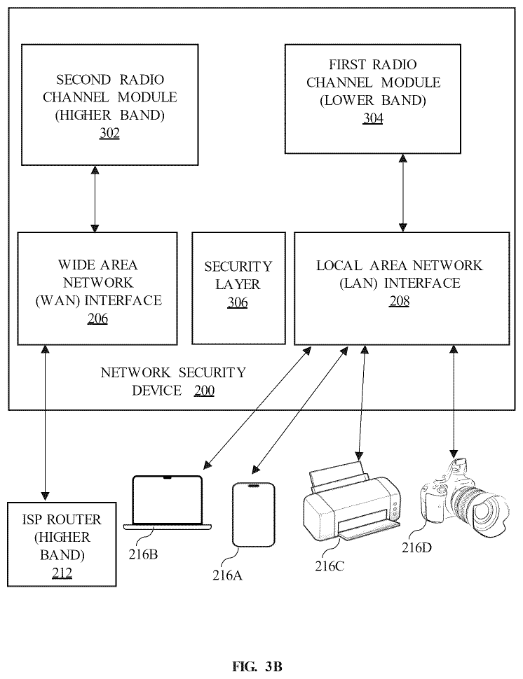

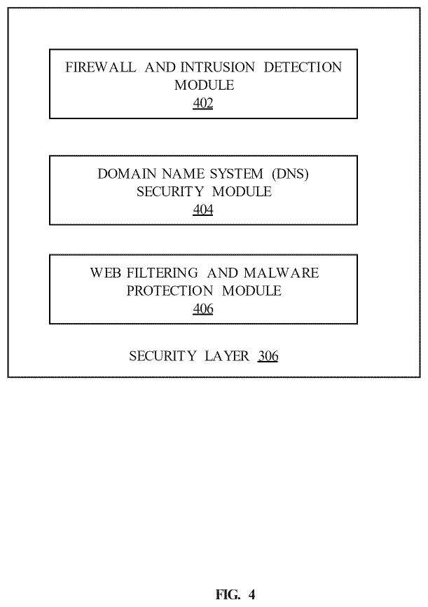

FIGS. 3A and 3B are block diagrams of a network security device 200 that assigns radio channels to an Internet Service Provider (ISP) router 212 and Wi-Fi-enabled devices 216A-N, according to some embodiments herein. The network security device 200 includes a Wide Area Network (WAN) interface 206, a Local Area Network (LAN) interface 208, a first radio channel module 302, a second radio channel module 304, and a security layer 306. The security layer 306 is operatively positioned between the WAN interface 206 and the LAN interface 208. The first radio channel module 302 includes a higher band. For example, the higher band may be in a range of 132 to 165 GHz. The second radio channel module 304 includes a lower band. For example, the higher band may be in a range of 36 to 64 GHz. The network security device 200 detects an operating frequency band of the ISP router 212. The network security device 200 determines optimal frequency bands for the Wi-Fi-enabled devices 216A-N based on the operating frequency band detected for the ISP router 212.

The network security device 200 dynamically assigns the first radio channel module 302 to the WAN interface 206 or the LAN interface 208 based on the operating frequency band detected for the ISP router 212 and the optimal frequency bands of the Wi-Fi-enabled devices 216A-N. For example, as shown in FIG. 3A, if the operating frequency band for the ISP router 212 is detected between the range of 36 to 64 GHz, the network security device 200 assigns (i) the first radio channel module 302 to the WAN interface 206, which is communicatively connected to the ISP router 212 and (ii) the second radio channel module 304 to the LAN interface 208, which is communicatively connected to the Wi-Fi-enabled devices 216A-N.

The network security device 200 dynamically assigns the second radio channel module 304 to the WAN interface 206 or the LAN interface 208 based on the operating frequency band detected for the ISP router 212 and the optimal frequency bands of the Wi-Fi-enabled devices 216A-N. For example, as shown in FIG. 3B, if the operating frequency band for the ISP router 212 is detected between the range of 132 to 165 GHz, the network security device 200 assigns the second radio channel module 304 to the WAN interface 206, which is communicatively connected to the ISP router 212 and (ii) the first radio channel module 302 to the LAN interface 208, which is communicatively connected to the Wi-Fi-enabled devices 216A-N.

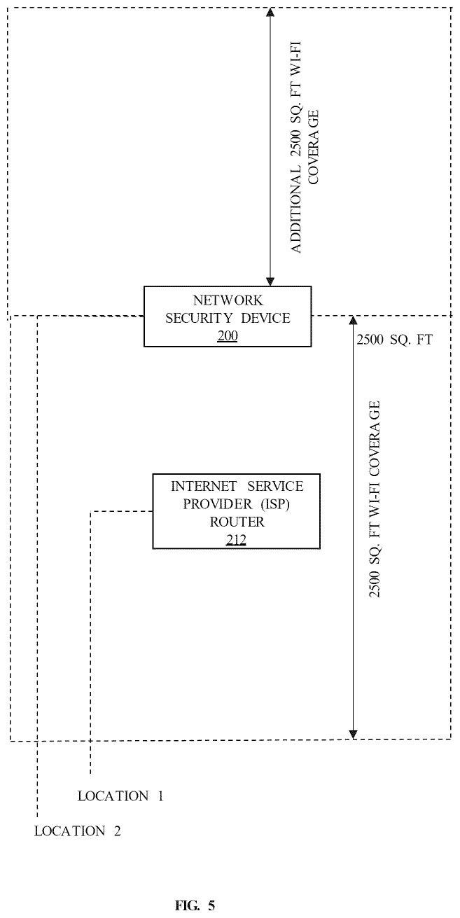

FIG. 4 are block diagrams of a security layer 306 that blocks unauthorized network traffic according to some embodiments herein. The security layer 306 includes a firewall and intrusion detection module 402, a Domain Name System (DNS) security module 404, and a web filtering and malware protection module 406. The security layer 306 includes pre-defined lists and a security policy. The security layer 306 detects and analyzes events in the network traffic. The security layer 306 determines whether the at least one event is associated with a predefined list provided by a user or third-party entities. For example, the event may be the Wi-Fi-enabled device 216A-N attempting to access a malicious website, downloading files from untrusted sources or suspicious patterns of communication.

The predefined lists include at least one domain name associated with known malicious sources, Internet Protocol (IP) addresses, or IP addresses from countries selected by the user or third-party entities as blocked. The domain names are specific websites or online services associated with known malicious actors, such as phishing sites, and malware distribution sites. The IP addresses are assigned to devices connected to the internet. The lists may include IP addresses of malicious servers, or hacker-controlled networks. The IP addresses from specific countries which means, in some cases, users or third parties may select to block traffic from entire countries or regions that are known for high volumes of malicious activity.

The security layer 306 compares the detected event against the predefined list to determine if the event should be blocked. If the security layer 306 detects the event (like the Wi-Fi enabled device 216 attempting to download the file), the GHz, the security layer 306 checks if the domain name or IP address associated with the event matches any on the predefined list of known malicious sources. If the event includes traffic from a blocked country, the network security device 200 blocks the event, (i.e.,) the security layer 306 blocks the network traffic corresponding to the event if the event is associated with the predefined list. The security layer 306 blocks unauthorized network traffic from reaching the ISP router 212 and the Wi-Fi enabled devices 216A-N.

The firewall and intrusion detection module 402 blocks network traffic associated the IP addresses if the IP addresses are within the predefined list of malicious IP addresses. The Domain Name System (DNS) security module 404 blocks network traffic associated with the domain name if the domain name is within the predefined list of malicious domain names. The web filtering and malware protection module 406 blocks network traffic to and from websites or IP addresses based on their security categorization and content type including phishing, ransomware, malware, weapons, drugs, adult content, and terrorism and hate content.

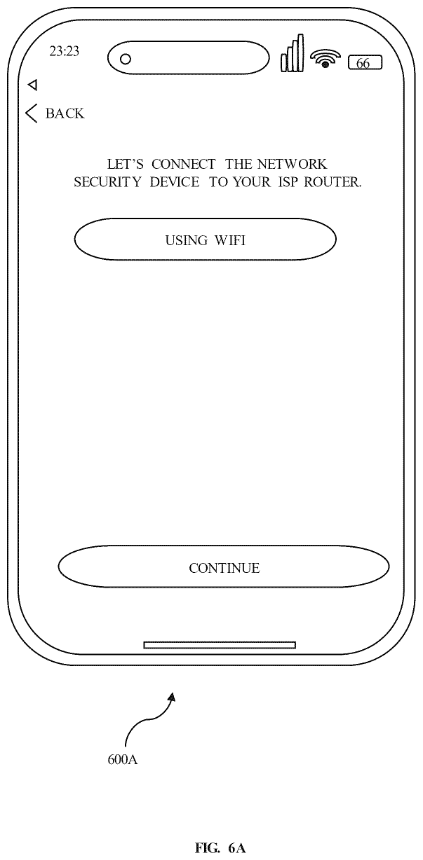

FIG. 5 is an exemplary diagram illustrating the extension of a Wi-Fi coverage of an Internet Service Provider (ISP) router 212 by a network security device 200 according to some embodiments. The network security device 200 connects to the ISP router 212, which provides a specific coverage area, for example, 2500 sq. ft. with a Wi-Fi 5 router. The network security device 200 can be placed anywhere within the maximum coverage area of the Wi-Fi network provided by the ISP router 212. By connecting to the ISP router 212, the network security device 200 doubles the Wi-Fi coverage. For example, if the ISP router 212 covers 2500 sq. ft., the network security device 200 extends the Wi-Fi coverage by an additional 2500 sq. ft. The network security device 200 extends the Wi-Fi coverage of the ISP router 212 by communicatively connecting the WAN interface with the ISP router 212. The WAN interface is configured to extend the Wi-Fi coverage of the ISP router 212 and provide the secured Wi-Fi network to the Wi-Fi-enabled devices connected to the ISP router 212.

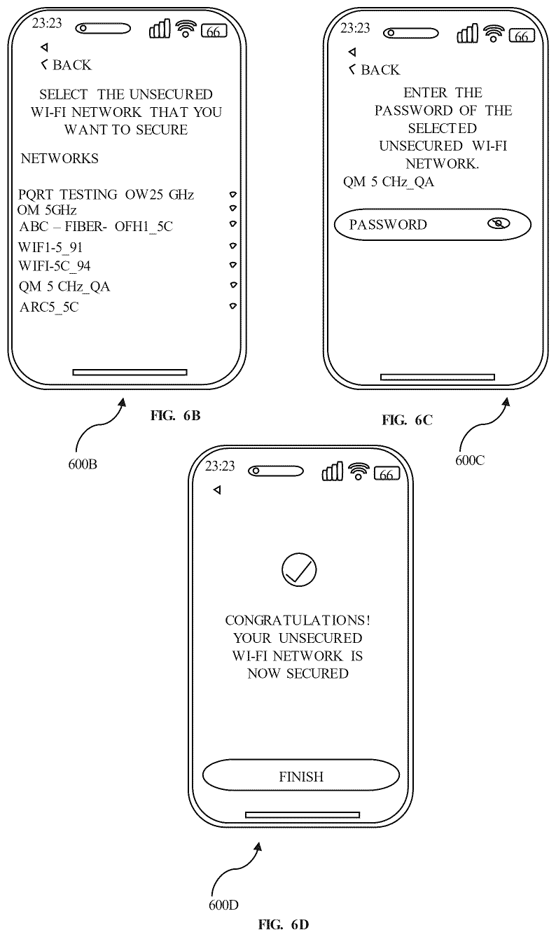

FIGS. 6A-D are exemplary user interface views 600A-D that illustrate a network security device being connected to an Internet Service Provider (ISP) router of a user according to some embodiments. The user interface view 600A depicts a message “Let's connect the network security device to your ISP router” and depicts that the connection method is “using Wi-Fi.” The user interface view 600A includes a “Continue” button. If the user wants to connect the network security device to their ISP router (i.e., an existing internet connection) to provide internet access, the user clicks the “Continue” option.

Once the user clicks the “continue” option, the user interface view 600B is displayed on a user device. The user interface view 600B depicts “select the unsecured Wi-Fi network that you want to secure” and depicts one or more available unsecured networks “PQRT TESTING OW25 GHz”, “OM 5 GHz”, “ABC-FIBER-OFH1_5C”, “WIF1-5_91, WIFI-5C_94, QM 5 CHz_QA, “ARC5_5C”.

Once the user clicks the “Continue” option, user interface view 600B is displayed on the user's device. This view prompts the user to “Select the unsecured Wi-Fi network that you want to secure” and depicts one or more available unsecured networks, such as “PQRT TESTING OW25 GHz,” “OM 5 GHz,” “ABC-FIBER-OFH1_5C,” “WIF1-5_91,” “WIFI-5C_94,” “QM 5 CHz_QA,” and “ARC5_5C”.

The user can select the unsecured Wi-Fi network associated with the ISP router from the one or more available unsecured Wi-Fi networks shown in user interface view 600B. If the user selects the “QM 5 CHz_QA” unsecured Wi-Fi network, user interface view 600C provides prompt to the user to “Enter the password of the selected unsecured Wi-Fi network.” Once the user enters the password for the “QM 5 CHz_QA” Wi-Fi network, the network security device connects to the ISP router. The user interface view 600D displays “Congratulations! Your unsecured Wi-Fi network is secured” once the network security device is connected to the ISP router.

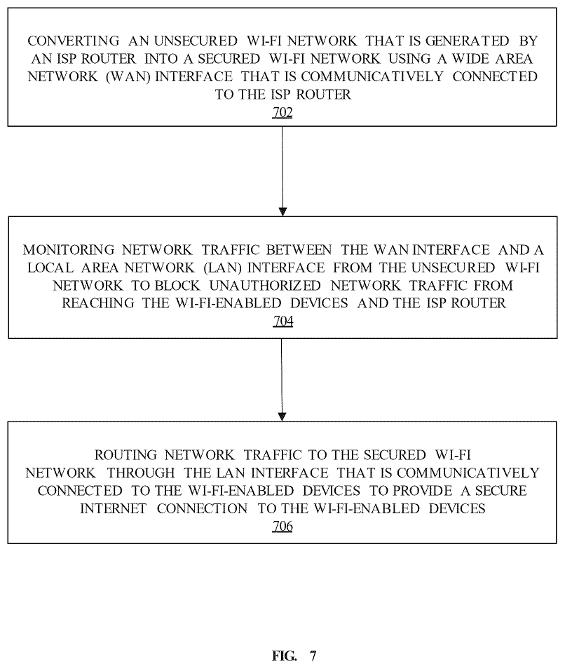

FIG. 7 is a flow diagram that illustrates a method for a network security device that operates as a network security Wi-Fi-enabled devices according to some embodiments herein. At a step 702, the method includes converting an unsecured Wi-Fi network that is generated by the ISP router into a secured Wi-Fi network using a Wide Area Network (WAN) interface that is communicatively connected to the ISP router. At a step 704, the method includes monitoring network traffic between the WAN interface and a Local Area Network (LAN) interface to block unauthorized network traffic from reaching the Wi-Fi-enabled devices and the ISP router. At a step 706, the method includes routing network traffic to the secured Wi-Fi network through the LAN interface that is communicatively connected to the Wi-Fi-enabled devices to provide a secure internet connection to the Wi-Fi-enabled devices.

The embodiments herein may include a computer program product configured to include a pre-configured set of instructions, which when performed, can result in actions as stated in conjunction with the methods described above. For an example, the pre-configured set of instructions can be stored on a tangible non-transitory computer-readable medium or a program storage device.

For an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

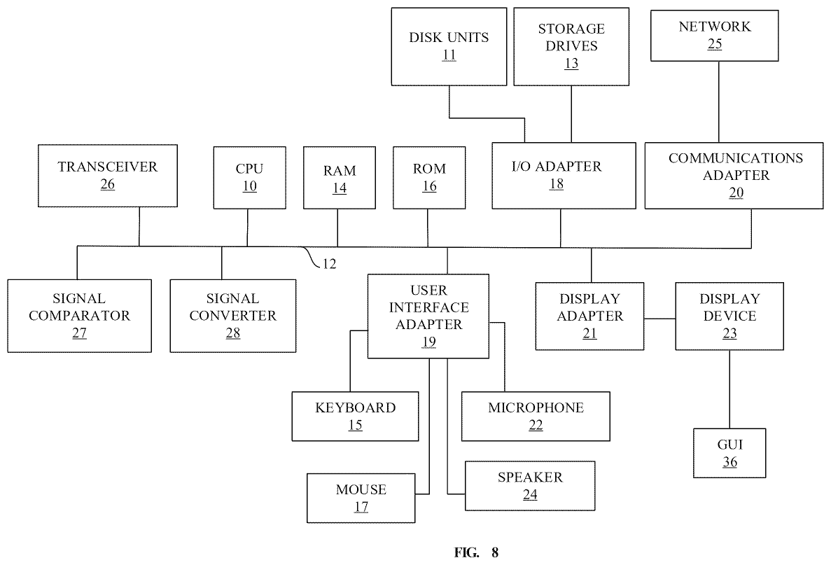

A representative hardware environment for practicing the embodiments herein is depicted in FIG. 8, with reference to FIGS. 2 through 7. This schematic drawing illustrates a hardware configuration of a server/computer system/Wi-Fi enabled device 216A-N in accordance with the embodiments herein. The network security device 200 includes at least one processing device 10. The special-purpose CPUs 10 are interconnected via system bus 12 to various devices such as a random-access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The viewer device 104A can read the inventive instructions on the program storage devices and follow these instructions to execute the methodology of the embodiments herein. The viewer device 104A further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23, which provides a graphical user interface (GUI) 29 of the output data in accordance with the embodiments herein, or which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A network security device that operates as a network security gateway for securing Wi-Fi-enabled devices, wherein the network security device comprises:
a memory that comprises a set of instructions; and
a processor that executes the set of instructions comprising:
converting an unsecured Wi-Fi network that is generated by the ISP router into a secured Wi-Fi network using a Wide Area Network (WAN) interface that is communicatively connected to the ISP router;
monitoring network traffic between the WAN interface and a Local Area Network (LAN) interface to block unauthorized network traffic from reaching the Wi-Fi-enabled devices and the ISP router; and
routing network traffic to the secured Wi-Fi network through the LAN interface that is communicatively connected to the Wi-Fi-enabled devices to provide a secure internet connection to the Wi-Fi-enabled devices.

2. The network security device of claim 1, wherein the set of instructions further comprises:
detecting an operating frequency band of the ISP router;
determining optimal frequency bands for the Wi-Fi-enabled devices based on the operating frequency band detected for the ISP router;
dynamically assigning the first radio channel module to the WAN interface or the LAN interface based on the operating frequency band detected for the ISP router and the optimal frequency bands of the Wi-Fi-enabled devices; and
dynamically assigning the second radio channel module to the LAN interface or the WAN interface based on the operating frequency band detected for the ISP router and the optimal frequency bands of the Wi-Fi-enabled devices,
wherein the first radio channel module and the second radio channel module are dynamically assigned and configured to reduce interference.

3. The network security device of claim 1, wherein the set of instructions further comprises:
extending a Wi-Fi coverage of the ISP router by communicatively connecting the WAN interface with the ISP router, wherein the WAN interface is configured to extend the Wi-Fi coverage of the ISP router and provide the secured Wi-Fi network to the Wi-Fi enabled devices connected to the ISP router.

4. The network security device of claim 1, wherein the set of instructions comprises:
converting the unsecured Wi-Fi network into the secured Wi-Fi network when a user selects the unsecured Wi-Fi network among a plurality of available unsecured Wi-Fi networks in the environment.

5. The network security device of claim 1, wherein the set of instructions further comprises:
monitoring the network traffic between the WAN interface module and the LAN interface module to detect at least one event;
determining whether the at least one event is associated with a predefined list provided by a user or third-party entities; and
blocking the network traffic corresponding to the event if the event is associated with the predefined list.

6. The network security device of claim 5, wherein the predefined lists comprise at least one domain name associated with known malicious sources, Internet Protocol (IP) addresses, or IP addresses from countries selected by the user or third-party entities as blocked.

7. The network security device of claim 1, wherein the network security device comprises a security layer that blocks the unauthorized network traffic, wherein the security layer comprises a firewall and intrusion detection module, a Domain Name System (DNS) security module, and a web filtering and malware protection module.

8. The network security device of claim 6, wherein the set of instructions further comprises:
updating the predefined lists dynamically at a predefined time.

9. A method for a network security device that operates as a network security gateway for securing Wi-Fi-enabled devices, the method comprising:
converting an unsecured Wi-Fi network that is generated by the ISP router into a secured Wi-Fi network using a Wide Area Network (WAN) interface that is communicatively connected to the ISP router;
monitoring network traffic between the WAN interface and a Local Area Network (LAN) interface to block unauthorized network traffic from reaching the Wi-Fi-enabled devices and the ISP router; and
routing network traffic to the secured Wi-Fi network through the LAN interface that is communicatively connected to the Wi-Fi-enabled devices to provide a secure internet connection to the Wi-Fi-enabled devices.

10. The method of claim 9, wherein the set of instructions further comprises:
detecting an operating frequency band of the ISP router;
determining optimal frequency bands for the Wi-Fi-enabled devices based on the operating frequency band detected for the ISP router;
dynamically assigning the first radio channel module to the WAN interface or the LAN interface based on the operating frequency band detected for the ISP router and the optimal frequency bands of the Wi-Fi-enabled devices; and
dynamically assigning the second radio channel module to the LAN interface or the WAN interface based on the operating frequency band detected for the ISP router and the optimal frequency bands of the Wi-Fi-enabled devices,
wherein the first radio channel module and the second radio channel module are dynamically assigned and configured to reduce interference.

11. The method of claim 9, wherein the set of instructions further comprises:
extending a Wi-Fi coverage of the ISP router by communicatively connecting the WAN interface with the ISP router, wherein the WAN interface is configured to extend the Wi-Fi coverage of the ISP router and provide the secured Wi-Fi network to the Wi-Fi enabled devices connected to the ISP router.

12. The method of claim 9, wherein the set of instructions further comprises:
converting the unsecured Wi-Fi network into the secured Wi-Fi network when a user selects the unsecured Wi-Fi network among a plurality of available unsecured Wi-Fi networks in the environment.

13. The method of claim 9, wherein the set of instructions further comprises:
monitoring the network traffic between the WAN interface module and the LAN interface module to detect at least one event;
determining whether the at least one event is associated with a predefined list provided by a user or third-party entities; and
blocking the network traffic corresponding to the event if the event is associated with the predefined list.

14. The method of claim 13, wherein the predefined lists comprise at least one domain name associated with known malicious sources, Internet Protocol (IP) addresses, or IP addresses from countries selected by the user or third-party entities as blocked.

15. The method of claim 9, wherein the network security device comprises a security layer that blocks the unauthorized network traffic, wherein the security layer comprises a firewall and intrusion detection module, a Domain Name System (DNS) security module, and a web filtering and malware protection module.

16. The method of claim 14, wherein the set of instructions further comprises:
updating the predefined lists dynamically at a predefined time.
